(19) United States
(12) Patent Application Publication
(10) Pub. No.: US 2019/0129155 A1
(43) Pub. Date: May 2, 2019

(54) DEVICE FOR GENERATING TEMPORALLY OFFSET, SPATIALLY MODULATED ILLUMINATION REGIONS

(71) Applicant: LaVision GmbH, Goettingen (DE)

(72) Inventors: Edouard Jean Jacques Berrocal, Lund (SE); Victor Elias Kristensson, Bjaerred (SE); Thomas Berg, Goettingen (DE)

(21) Appl. No.: 16/083,542

(22) PCT Filed: Mar. 15, 2017
(86) PCT No.: PCT/EP2017/056097

§ 371 Date: Sep. 10, 2018

(30) Foreign Application Priority Data
Mar. 15, 2016 (DE) 10 2016 104 784.8

(51) Int. Cl. G02B 21/06; G02B 27/10; G02B 27/28; G02B 21/36

(52) U.S. Cl. CPC G02B 21/06; G02B 21/36; G02B 27/283; G02B 27/10

(57) ABSTRACT

A device is provided for generating temporally offset, spatially modulated illumination regions (22, 22′) having periodic modulation patterns that are phase-shifted with respect to one another. The device has two pulsed laser sources (121, 122) that are triggerable in a manner temporally offset with respect to one another and that generate two laser beams pulsed in a temporally offset manner. Intensity modulators (16) are provided for spatially periodic intensity modulation of the laser beams perpendicular to the direction of propagation thereof. A beam superimposing device (126) combines the beam paths of the laser beams in a common beam path section and a beam shaper (20, 20′) shapes the illumination region shaping. The common beam path section is configured so that the laser beams combined by the beam superimposing device (126) are polarized differently and the intensity modulators are upstream of an optically anisotropic beam splitter (18).

### BACKGROUND

### Field of the Invention

The invention relates to a device for generating temporally offset, spatially modulated illumination regions having periodic modulation patterns that are phase-shifted with respect to one another. More particularly, a device of this type has two pulsed laser sources that are triggerable in a manner temporally offset with respect to one another and that function to generate two laser beams pulsed in a temporally offset manner. A device of this type also has intensity modulation means for the spatially periodic intensity modulation of the laser beams perpendicular to the direction of propagation thereof, beam superimposing means for combining the beam paths of the laser beams in a common beam path section and beam shaping means for illumination region shaping.

### Related Art

A device of the type mentioned in the preceding paragraph is described in Kristensson, E. et al.: “Two-pulse structured illumination imaging”, OPTICS LETTERS, Vol. 39, No. 9 (2014).

The aforementioned publication of Kristensson et al. discloses a method characterized as SLIPI (Structured Laser Illumination Planar Imaging) and a device suitable for its implementation. SLIPI is an imaging technology that is often used for imaging-based analysis of flow processes, in particular spray processes. In particular, the technology is geared toward suppressing the intensity contributions that arise from light diffused multiple times in a spray cloud.

The use of so-called light sections in the optical measurement of flows is generally known. The term “light section” in this context essentially refers to a disc-shaped illumination region that extends through a measurement volume. Its extension in the thickness direction is substantially smaller than its extension in the two spatial dimensions that are perpendicular thereto. Such light sections are generally generated by compression of an expanded laser beam in the thickness direction by means of cylindrical optics. The height of the light section is determined by the height of the underlying laser beam. The width direction of the light section corresponds to the direction of propagation of the laser beam.

In the SLIPI method, multiple images of a measurement volume illuminated by means of such light sections, said images succeeding one another in very fast time progression, are captured and set against each other for further processing. The computer handling of the captured images is not relevant for the present invention. The important thing in the SLIPI method is that the light sections assigned to the individual images differ from each other in a specific way, even though they illuminate essentially the same area. Thus, light sections that in particular are spatially differently modulated are used. A light section that is spatially modulated is understood in this case to be a light section whose intensity varies in the vertical direction of the light section. In the case of a modulation with a periodic modulation pattern, the light section receives an intensity distribution that varies periodically over its elevation. In simple terms, this can be referred to as a “striped pattern.” In the case of SLIPI, sinusoidal modulation patterns in particular are used.

The basis of the SLIPI method is to capture successive images in which the measurement volume was illuminated by means of light sections whose modulation patterns have a defined phase shift with respect to one another. In the case of the two-pulse-SLIPI method disclosed in the aforementioned publication, the goal is in particular to capture exactly two images in which the modulation patterns of the assigned light sections differ by a phase shift of 180°. In the case of the previously already simplistically termed “striped pattern,” this means essentially that during the capture of the second image the regions appearing as dark stripes in the first image are then illuminated as light-colored stripes and vice-versa. Generally speaking, in the second image the intensity maxima of the assigned light section fall within those regions in which the intensity minima of the light section assigned to the first image were arranged.

The practical generation of such temporally offset, spatially modulated light sections with periodic modulation patterns that are phase-shifted with respect to one another has proven to be difficult. Because of the typically desired, very short temporal offset, it is usually necessary to use different pulsed laser sources that can be triggered relative to each other with the desired temporal offset. However, the beam paths of the two laser beams must be combined at least in the region of the light sections that occupy the same illumination space. In the cited publication, it is proposed to effect the beam expansion and intensity modulation before the beam paths are combined, i.e. separately for each laser beam. For this purpose, each beam path is provided with its own expansion optics and its own intensity modulation means, for example, an aperture mask in the shape of a linear grating. Next, the spatially intensity-modulated laser beams are superimposed by beam superimposing means, for example, a Brewster combiner, to form the common beam path section. The beam shaping required for configuration of the light section is then carried out jointly for the two laser beams in the common beam path section. This involves maximum effort with regard to the required adjustment. In particular, the intensity modulation means must be adjusted relative to each other in such a way that the modulation patterns of the resulting light sections have the desired phase shift in relation to one another.

The present invention seeks to solve the problem of further developing a device of the type described above in such a way that the adjustment effort is reduced.

### SUMMARY

The invention relates to a device for generating temporally offset, spatially modulated illumination regions having periodic modulation patterns that are phase-shifted with respect to one another. More particularly, the device has two pulsed laser sources that are triggerable in a manner temporally offset with respect to one another and that function to generate two laser beams pulsed in a temporally offset manner. The device also has intensity modulation means for the spatially periodic intensity modulation of the laser beams perpendicular to the direction of propagation thereof, beam superimposing means for combining the beam paths of the laser beams in a common beam path section and beam shaping means for illumination region shaping. The common beam path section is configured so that the laser beams combined by the beam superimposing means are differently polarized and the intensity modulation means are arranged upstream of an optically anisotropic beam splitter.

The invention uses the principle of birefringence on an optically anisotropic medium. As is known, birefringent media have the property that, as long as it does not incide parallel to the crystallographic main axis of the medium, light of differing polarity experiences different refractive indices in the medium, i.e. it is deflected with varying intensity in the medium.

This effect is of benefit to the invention in that it initially provides differing polarities of the laser beams to be superimposed. Despite being combined via the beam superimposing means, the two laser beams are therefore still distinguishable also in the common beam path section. This also applies after the passage through common intensity modulation means, such as a corresponding pattern aperture in the region of the common beam path. Downstream of the common intensity modulation means, the two laser beams are modulated identically. However, during the passage through the subsequent optically anisotropic beam splitter, the differently polarized laser beams take different paths, resulting in a corresponding spatial offset of the respective modulation patterns. Direction and magnitude of the offset depend on the specific birefringence properties and the thickness of the optically anisotropic beam splitter as well as on the angle of incidence of the laser beams on the optically anisotropic beam splitter relative to its crystallo-optical main axis. By appropriate adjustment of the optically anisotropic beam splitter, the exact phase offset of the modulation patterns can thus be set in the light sections. A person skilled in the art will recognize that, to generate light sections which—apart from the phase offset—are congruent, it is beneficial to provide the optically anisotropic beam splitter with a basic adjustment that makes the deflection of the laser beams relative to each other occur exclusively in the direction of the vertical extension of the light sections. In the case of relative deflection that is only perpendicular thereto, no phase offset of the modulation pattern would ensue; in the case of a relative deflection that is also perpendicular thereto, a spatial offset of the light sections relative to each other in the thickness direction would result. In cases also covered by the invention in which the illumination regions are actual illumination volumes, i.e. regions whose thickness and vertical dimensions have roughly equal magnitudes, an additional phase offset perpendicular to the offset in the vertical extension can be harmless.

The invention therefore has the effect that the intensity modulation of the two beams with common beam superimposing means can take place in the common beam path section and the phase offset of the modulation pattern can be accomplished just by adjusting an individual element, namely the optically anisotropic beam splitter. This constitutes a substantial reduction in the adjustment effort.

The adjustment of the optically anisotropic beam splitter is especially simple if it is pivotable about a pivot axis that is perpendicular to the direction of propagation of the laser beams.

The desired modulation pattern can be generated in many ways, among which the use of an aperture mask in the shape of a linear grating is cited purely as one example here.

Preferably, it is provided that the pulsed laser sources supply aligned polarized laser beams, and that polarization modification means for rotating the polarization of the assigned laser beam by an angle corresponding to a predetermined polarization difference, in particular 90°, are arranged between the beam superimposing means and one of the pulsed laser sources. This is due to the technical as well as economical consideration that largely identical light sections are preferably generated using largely identical laser beams, which in turn are most advantageously generated for their part by identically structured laser sources. However, identically structured laser sources generate laser beams of the same polarity. Accordingly, it is required, before combining the beam paths, to rotate the polarity of one of the laser beams, which, for a desired rotation of 90° using, for example, standard commercially available λ/2 plates, is easy for a person skilled in the art. In principle, linear as well as circular polarized light can be used. However, due to the customary design of economical lasers, in practice linear polarized light is typically used.

Advantageously, the pulsed laser sources and the beam superimposing means are combined in a common light source module. Light source modules of this type are available on the market with two temporally offset triggerable pulsed laser sources and internal beam path superimposition—even if for other purposes—as preconfigured units. The model series “Terra PIV” from the company Continuum in San Jose, Calif. is mentioned here purely as an example.

It is especially advantageous if the polarization modification means are additionally included in the common light source module. This is the case with the aforementioned preconfigured devices and finds its rationale in particular in the fact that the beam superimposing means include a polarization-sensitive Brewster combiner.

The invention therefore makes available a new use for light source modules of this type, namely as laser sources for two-pulse SLIPI methods.

Additional features and advantages of the invention are evident from the following detailed description and the drawings.

### BRIEF DESCRIPTION OF THE DRAWINGS

FIG. 1 is a schematic side view of a first embodiment of a device according to the invention,

FIG. 2 is a top view of the device of FIG. 1,

FIG. 3 is a schematic side view of a second embodiment of a device according to the invention,

FIG. 4 is a top view of the device of FIG. 3.

### DETAILED DESCRIPTION

Identical reference symbols in the figures indicate identical or similar elements.

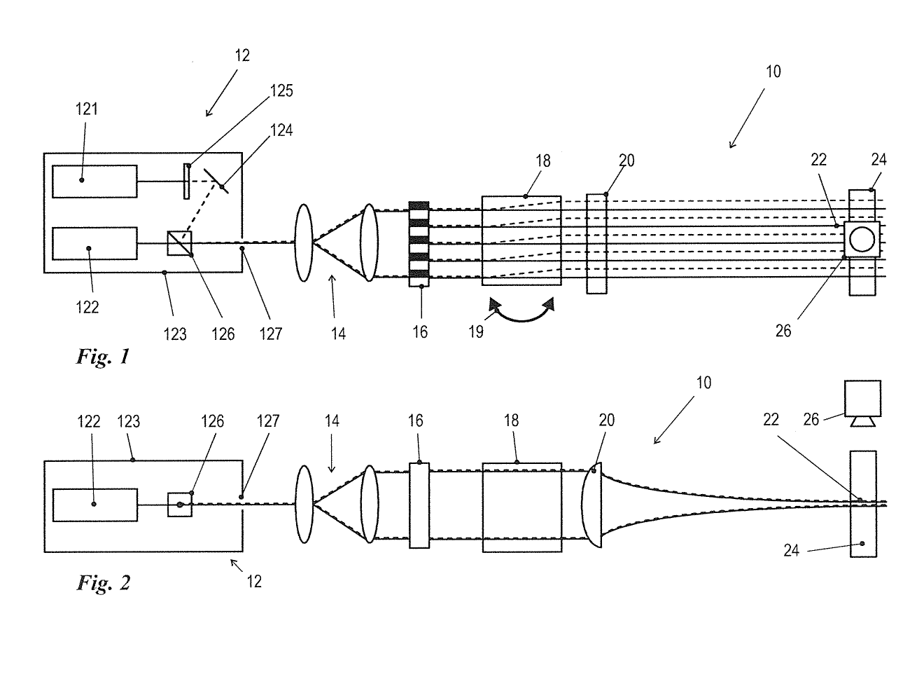

FIGS. 1 and 2 show a very schematic representation of a light section generation device 10 according to the invention in two different views. Whereas FIG. 1 shows a side view for the illustration of the modulation pattern offset according to the invention, FIG. 2 represents a top view of the same device 10 for the illustration of the light section formation. Both figures will be discussed jointly below.

Depicted to the left in the figures is a light source module 12 that comprises two pulsed laser sources 121, 122 which are triggerable in a manner temporally offset with respect to one another. They are integrated in a housing 123. The pulsed laser sources 121, 122 are preferably identically designed and consequently supply pulsed laser beams with identical optical properties. In particular, the laser beams in the depicted embodiment have identical polarities. The beam of the upper pulsed laser source 121 in FIG. 1 is directed via a deflection mirror 124 inside the housing 123 onto a λ/2 plate 125, resulting in a 90° rotation of its polarization. The corresponding laser beam is therefore represented in its further course by dashed lines. By means of a beam combiner 126, which is also contained within the housing 123, the beams of the two pulsed laser sources 121, 122 are combined into a common beam path region. The combined beam is characterized in its subsequent course by the parallel guidance of one dashed line and one solid line, which, however, is explicitly not supposed to represent a narrow parallel guidance of the two beams, but instead the guidance on an essentially identical beam path. A person skilled in the art will recognize that this is the ideal case to be pursued. In practice, however, slight deviations from the identical beam guidance will also be tolerable.

The combined beam exits the light source module 12 through an exit window 127 in its housing 123.

By means of downstream beam expansion optics 14, the combined beam is expanded and supplied to an intensity modulator 16. This is configured in the shown embodiment as an aperture mask in the shape of a linear grating.

Next, the intensity-modulated beam is supplied to an optically anisotropic beam splitter 18. The specific structure of the optically anisotropic beam splitter 18 is not of concern for the present invention. What is important is just its function of deflecting differently polarized light components in a different way. A comparison of FIGS. 1 and 2 shows the preferred basic adjustment of the optically anisotropic beam splitter 18 according to which a relative offset of the differently polarized beams takes place exclusively in the vertical direction of the light section to be formed. This is perpendicular to the modulation direction of the intensity modulator and perpendicular to the modulation direction of the intensity modulation pattern in the resulting light section. The dimension of the relative offset is preferably adjustable. For this purpose, the optically anisotropic beam splitter 18 is preferably pivotably arranged as depicted by the pivot arrow 19, preferably about a pivot axis oriented perpendicular to the direction of propagation of the beam and perpendicular to the beam offset direction.

The function of the subsequent elements can best be explained in reference to FIG. 2. In beam shaping means 20 that connect to the optically anisotropic beam splitter 18 and can in particular comprise cylindrical optics, compression of the laser beams, which are then offset relative to one another, takes place namely preferably exactly perpendicular to the relative offset direction and of course perpendicular to the direction of beam propagation. In this way the light sections 22 are produced along with their spatially periodic modulation patterns, which are phase-shifted with respect to each other. The temporally offset triggering of the pulsed laser sources 121, 122 thereby results in the illumination of a measurement volume 24 in short temporal sequence with congruent light sections 22, which, however, exhibit a phase shift of their spatial modulation pattern relative to one another.

With an observation camera 26, images of the measurement volume 24 can be captured with said differing illuminations. These images can then be supplied to any type of evaluation, in particular according to the two-pulse SLIPI method.

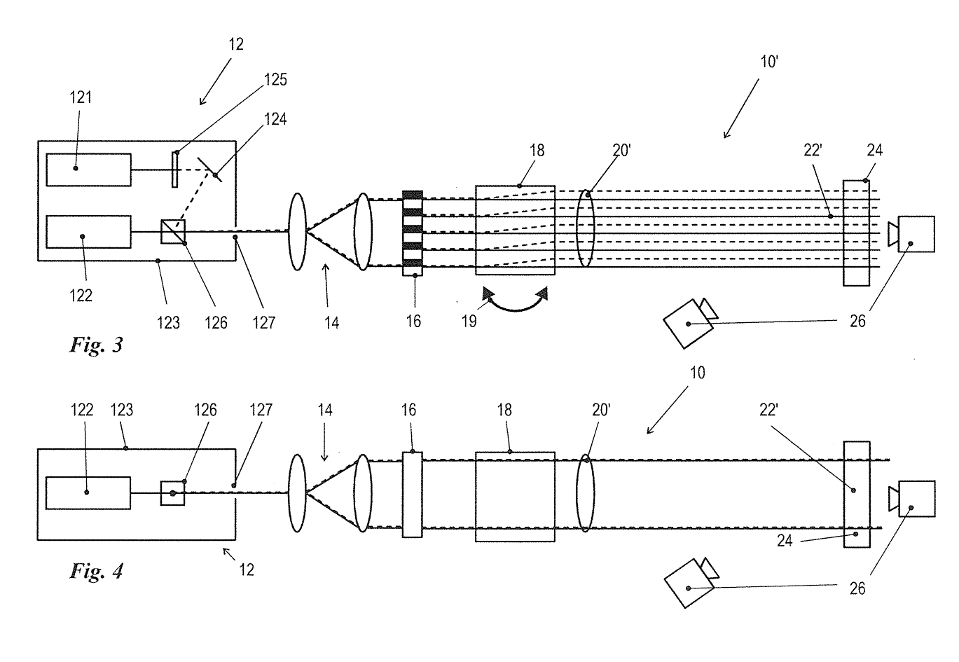

FIGS. 3 and 4 represent a variation of the structure of FIGS. 1 and 2 and are described below solely on the basis of the differences. In other respects, reference is made to what was stated above.

In the illumination device 10′ of FIGS. 3 and 4, instead of a light section an actual illumination volume whose vertical and thickness extensions are essentially equal is generated as illumination region 22′. This is most easily achieved if the beam forming optics 20′ do not include any cylindrical optics, so that a compression, as in the structure of FIGS. 1 and 2, is avoided. Arrangements of this type may play a role in particular in the area of microscopy. An observation of the measurement volume 24 in the forward and/or reverse dispersion is regarded as beneficial. The doubly indicated observation cameras 26 are therefore to be understood as alternative to or in addition to one another.

Of course, the embodiments discussed in the specific description and shown in the figures are merely illustrative exemplary embodiments of the present invention. In the light of the present disclosure, a person skilled in the art has available a broad spectrum of optional variations. It should be noted that the observation optics for the cameras 26 can be substantially more complex than is rudimentarily indicated in the figures. Both direct and indirect observation via an interposed projection screen are conceivable. Beam diversions via beam splitters are also possible. Likewise, the magnification range of the observation plays no role for the principle of the invention.

### REFERENCE LIST

10 Light section generating device
10′ Illumination device
12 Light source module
121 Pulsed laser source
122 Pulsed laser source
123 Housing
124 Deflection mirror
125 λ/2 plate
126 Beam combiner
127 Exit window
14 Expansion optics
16 Intensity modulator, aperture mask
18 Optically anisotropic beam splitter
19 Pivot arrow
20 Beam shaping optics with cylindrical optics
20′ Beam shaping optics without cylindrical optics
22 Illumination region, light section
22′ Illumination region, illumination volume
24 Measurement volume
26 Observation camera

1. A device for generating temporally offset, spatially modulated illumination regions (22, 22′) having periodic modulation patterns that are phase-shifted with respect to one another, comprising
two pulsed laser sources (121, 122), which are triggerable in a manner temporally offset with respect to one another and which serve for generating two laser beams pulsed in a temporally offset manner,
intensity modulation means (16) for the spatially periodic intensity modulation of the laser beams perpendicular to the direction of propagation thereof,
beam superimposing means (126) for combining the beam paths of the laser beams in a common beam path section and
beam shaping means (20, 20′) for illumination region shaping, wherein
the common beam path section is configured so that the laser beams combined by the beam superimposing means (126) are differently polarized, and
the intensity modulation means are arranged upstream of an optically anisotropic beam splitter (18).

2. The device of claim 1, wherein
the illumination regions (22, 22′) are designed as light sections (22).

3. The device of claim 2, wherein
the beam shaping means (20) comprise cylindrical optics.

4. The device of claim 1, wherein
the illumination regions (22′) are designed as illumination volumes.

5. The device of claim 1, wherein
the optically anisotropic beam splitter (18) is pivot-mounted about a pivot axis that is perpendicular to the direction of propagation of the laser beams.

6. The device of claim 1, wherein
the intensity modulation means (16) are configured as an aperture mask in the shape of a linear grating.

7. The device of claim 1, wherein
the pulsed laser sources (121, 122) supply aligned polarized laser beams, and polarization modification means (125) for rotation of the polarization of the assigned laser beam by an angle corresponding to a predefined polarization difference are arranged between the beam superimposing means (126) and one of the pulsed laser sources (121).

8. The device of claim 7, wherein
the polarization difference is 90°.

9. The device of claim 1, wherein
the pulsed laser sources (121, 122) and the beam superimposing means (126) are combined in a common light source module (12).

10. The device of claim 9, wherein
the polarization modification means (125) are additionally included in the common light source module (12).

11. The device of claim 8, wherein
the polarization modification means (125) are additionally included in the common light source module (12).
